(19) United States
(12) Patent Application Publication
(10) Pub. No.: US 2016/0195613 A1
(43) Pub. Date: Jul. 7, 2016

(54) Dual Mode Undercarriage Vehicle Inspection System

(71) Applicant: Robert M. Knox, Geneva, IL (US)

(72) Inventor: Robert M. Knox, Geneva, IL (US)

(21) Appl. No.: 14/589,335

(22) Filed: Jan. 5, 2015

(51) Int. Cl. G01S 13/86

(52) U.S. Cl. CPC G01S 13/867

(57) ABSTRACT

An undercarriage vehicle inspection system (UVIS) disposed below a rail bed or road way uses an array of dual mode sensors comprised of short range, high resolution radar sensors disposed with high resolution electro-optical sensors, sharing identical field-of-regard, positioned to illuminate a small sector of the vehicle underside, to collect sensor signatures over the small sector, fuse the signatures from the radar and electro-optical sensors, create a three-dimensional map record of the undercarriage when the vehicle passes overhead. The dual mode sensor array processor collects signatures across the width of the vehicle undercarriage to create a strip map record. As the vehicle passes overhead the dual mode UVIS, repeats that signature collection method until strip maps are created and stored representing the entire vehicle undercarriage. The undercarriage array map consists of three- dimensional cells having metrics for length (L) across the undercarriage, width (W) in direction of vehicle undercarriage. The dual mode array map cell signatures collectively represent the entire underside contour data file that is collected and recorded for future comparison. In subsequent passage of the subject vehicle over the dual mode sensor array a new three-dimensional data record is generated by the system processor and subjected to comparison with earlier recorded three-dimensional data record for the vehicle to search for change in the three-dimensional data record. Change in the data record for one or more cells across one or more strips over the length of the vehicle will cause the processor to activate an alert device for a human operator for purpose of subsequent inspection by the human operator whether the change is indication of terrorist threat or need for maintenance of the underside equipment.

### REFERENCES CITED

U.S. Pat. No. 8,067,719 B2 November 2011 Herrera, etal

U.S. Pat. No. 7,102,665 B1 September 2006 Chandler, etal

U.S. Pat. No. 6,856,344 B2 February 2005 Franz

### PUBLICATIONS CITED

Ahuja, N. & Barkan, C. “Machine Vision for Railroad Equipment Undercarriage Inspection Using Multi-Spectral Imaging”, Report to the Transportation Research Board of the National Academies; Final Report for High Speed Rail IDEA Project 49; December 2007

All current references and published literature for undercarriage vehicle inspection system are based on using video camera sensor to create and store a two dimensional image of the undercarriage. While computer algorithms based on machine vision programs are used to search for anomalous change in the detected image in current systems, there is little or no depth information about the anomaly to confirm that an actual anomaly is detected that is the object of the inspection method. Result is that human inspection is required before anomaly detection by the UVIS can be verified. This shortcoming results in missed anomaly detections and/or false anomaly detections. The present invention replaces the use of an image processing method and instead relies upon a three dimensional cell map of the undercarriage so that depth information is included when new inspection scans are compared with archived inspection scans for a given vehicle. The three dimensional map is enabled by use of dual sensor modes; that is use of co-bore-sighted high resolution radar with electro-optical camera. This use of three dimensional mapping assures higher reliability of the comparison method allowing the anomaly detection to be automated and reliable alert provided to an operator for subsequent action (anomaly removal or undercarriage maintenance/repair). This system method takes less time, has higher probability of reliable detection, reduces false detections and costs less to operate (requiring less human labor).

Table of Claim Limitations Vs References

| Claim # and Summary | Pat 6,856,344 B2 | Pat 7,102,655 B1 | Pat 8,067,719 B2 |
|---|---|---|---|
| 1 Sensor map grid array | Sensor is linear array | Sensor is plurality | Sensor is a linear array |
| of radar plus EO/IR sensors; | of EO/IR type; | of EO/IR type; | of one or more EO/IR |
| Undercarriage 3D | Undercarriage record | Undercarriage record | type; Undercarriage |
| Record fusing output of | is an image stitched | is an image stitched | record is an image |
| two sensors; Three | from linear array of | from plurality of sensors; | stitched from a line scan |
| dimensional record (not a | sensors; Two dimensional | Two dimensional image | or linear array of sensors; |
| 2D image) | image record | record | Two dimensional image record |
| 2 Undercarriage illuminated | No radar sensor or other | No radar sensor or | No radar sensor or other |
| by second sensor, radar | means to measure range | other means to measure | means to measure range to |
| enables 3D record by adding | to the undercarriage; range | range to the undercarriage; | the undercarriage; Record is |
| high resolution measure of | finder only for position of | Record is only 2D | only 2D image, no 3D fusion |
| range to the undercarriage | vehicle over the inspection | image, no 3D fusion | |
| | system; Record is only | for record | |
| | 2D image, no 3D fusion | | |
| | for record | | |
| 3 Crosswise strip record is | Crosswise strip record | Crosswise strip record | Crosswise strip record |
| is created from multiplicity | is 2D image created from | is 2D image created | is 2D image created |
| of radar sensors for fusion | EO/IR cameras. No radar | from EO/IR cameras. | from EO/IR cameras. |
| to a 3D map record | or other ranging device | No radar or other ranging | No radar or other ranging |
| | | device | device |
| 4 Multiplicity of EO/IR sensors | EO/IR sensors are the | EO/IR sensors are the | EO/IR sensors are the |
| is disposed with and co-bore | only source of undercarriage | only source of undercarriage | only source of undercarriage |
| sighted to multiplicity of radar | image; not disposed with | image; not disposed with | image; not disposed with |
| sensors | any ranging device | any ranging device | any ranging device |
| 5 Data output of radar and EO/IR | Single EO/IR sensor type | Single EO/IR sensor type | Single EO/IR sensor type |
| sensors are fused to create 3D | has no second sensor type | has no second sensor type | has no second sensor type |
| map record | to use for creation of 3D | to use for creation of 3D | to use for creation of 3D |
| | record | record | record |
| 6 Method where output of | No fusion takes place | No fusion takes place | No fusion takes place |
| radar and EO/IR sensors is | in the method | in the method | in the method |
| directly fused from raw sensor | | | |
| data | | | |
| 7 Alternative method; 2D map | No fusion takes place | No fusion takes place | No fusion takes place |
| from EO/IR sensors is created; | in the method | in the method | in the method |
| range map from radar is | | | |
| created; fusion of the two maps | | | |
| creates 3D recor | | | |
| 8 Data processor with algorithms | Processor algorithms only | Processor algorithms only | Processor algorithms only |
| capable of operating on data in | capable of comparison of | capable of comparison of | capable of comparison of |
| undercarriage three dimensional | current undercarriage image | current undercarriage image | current undercarriage image |
| grid map to recognize change | with archival | with archival | with archival |
| in cell data from current three | undercarriage image | undercarriage image | undercarriage image |
| dimensional grid map to an | | | |
| archival three dimensional grid | | | |
| map | | | |
| 9 Short range high range | Only video | Only video | Only video |
| resolution millimeter wave FM- | cameras | cameras | cameras |
| CW radar sensor with | used that are not | used that are not | used that are not |
| small aperture, narrow beam | capable of high | capable of high | capable of high |
| antennas for undercarriage | resolution | resolution | resolution |
| signature record | undercarriage | undercarriage | undercarriage |
| 10 EO/IR sensors capable of day | Camera sensors not | Camera sensors not co- | Camera sensors not co- |
| or night operation in cluttered | co- | bore sighted with any | bore sighted with any |
| environment providing to a | bore sighted with any | form of ranging device | form of ranging device |
| processor undercarriage | form of ranging device | thereby enabling only | thereby enabling only |
| signatures for fusion with co- | thereby enabling only | two dimensional | two dimensional |
| bore sighted radar signatures to | two dimensional | image rather than | image rather than |
| enable three dimensional map | image rather than | three dimensional | three dimensional |
| record | three dimensional | map | map |

### TECHNICAL FIELD

The technical field relates to vehicle undercarriage inspection for purpose of detection of change in a three-dimensional cell map of the undercarriage compared with previous inspections for purpose of identification of possible terrorist object or notation of need for vehicle maintenance or repair.

### BRIEF DESCRIPTION OF THE DRAWINGS

FIG. 1 is a block diagram for the dual mode undercarriage vehicle inspection system indicating the movement of the vehicle over the sensor system disposed below the rails or roadway on which the vehicle is moving.

FIG. 2 is a second block diagram for the dual mode undercarriage vehicle inspection system in which a dual array of radar and electro-optical sensors is indicated.

FIG. 3 shows the entire undercarriage of a typical rail vehicle upon which is indicated the horizontal grid sector coverage location for three dimensional cells

### DETAILED DESCRIPTION OF THE INVENTION

A dual mode apparatus and method for capturing and recording vehicle undercarriage three-dimensional configuration uses a map grid array undercarriage vehicle inspection system (UVIS) to characterize the undercarriage of vehicles, such as passenger, commercial, and military vehicles. The UVIS may be used with security and access control applications to inspect the undercarriage of vehicles to detect contraband, explosives, and other security breach items and/or to detect component deterioration or abnormal function before component failure. The UVIS will automatically detect the presence of anomalous component and/or absence of component of any vehicle that travels over the embedded dual mode map grid array system. Once a vehicle is detected, the UVIS equipment automatically captures a high-resolution three-dimensional map grid array record of the vehicle's undercarriage structure. One or more scene cameras can be used to capture other vehicle scene images associated with the vehicle movement, position and its passengers.

The undercarriage map grid array record and the associated vehicle scene images may be immediately transmitted to a processor through a network, such as Ethernet or wireless network. The processor contains algorithms to compare the map grid array record with an archived map grid array record for the same vehicle and autonomously determine if an anomaly exists between the archived map grid array record and the detected map grid array record. If an anomaly is detected, an alert is displayed on an alert device at an operator workstation for the attention of a human operator or inspector. Real- time map grid array records, as well as historical vehicle map grid array records and other vehicle information, such as vehicle license number, radio frequency identification (RFID) tag, vehicle description, and owner or passenger's name may be stored in a database repository, such as a relational database, connected to the network, and can be retrieved and compared with other passage events at a later time. An operator can also archive all of the screening results and information for future reference and comparisons. For example, if an undercarriage inspection of a passing vehicle alerts for the indication of anomalous material, such as contrabands and explosives, the vehicle can be identified and traced using the information saved in the database.

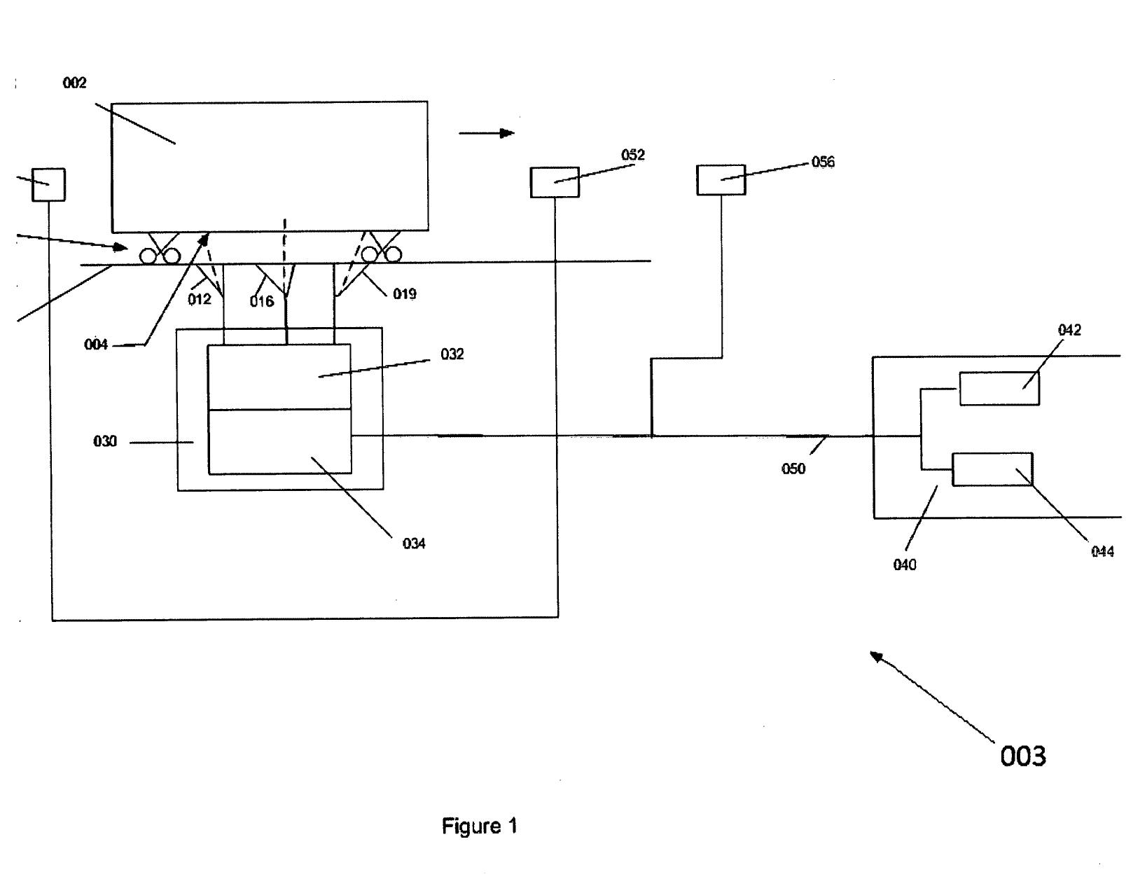

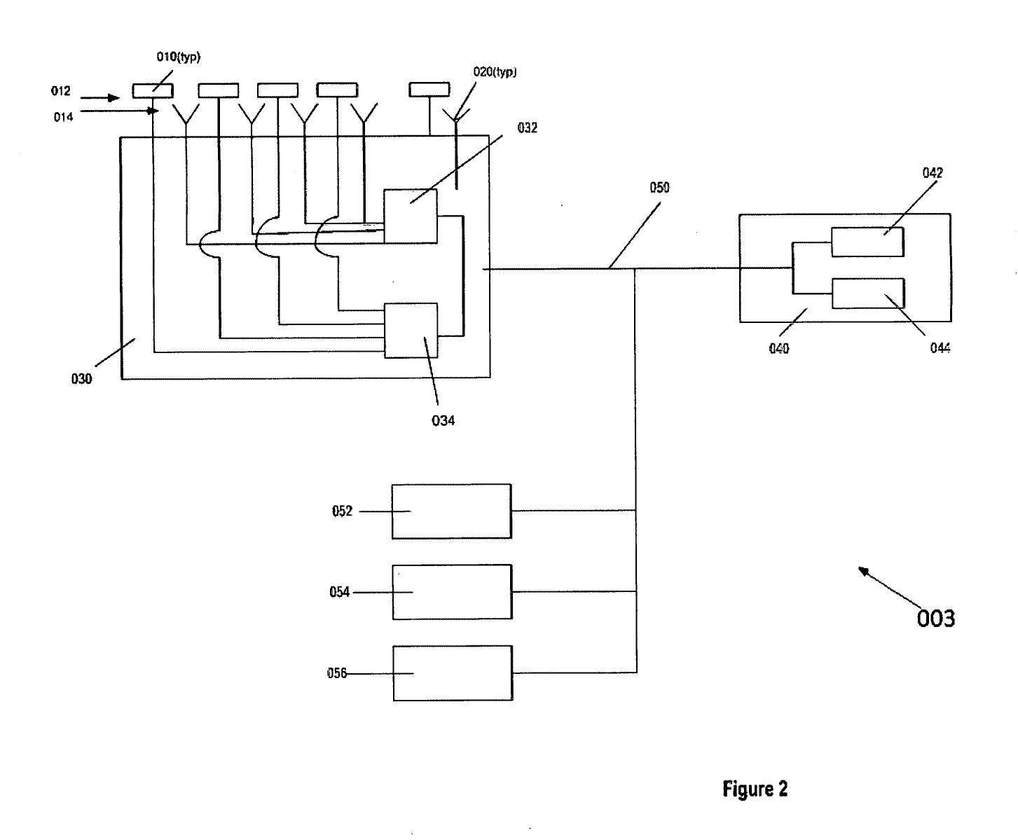

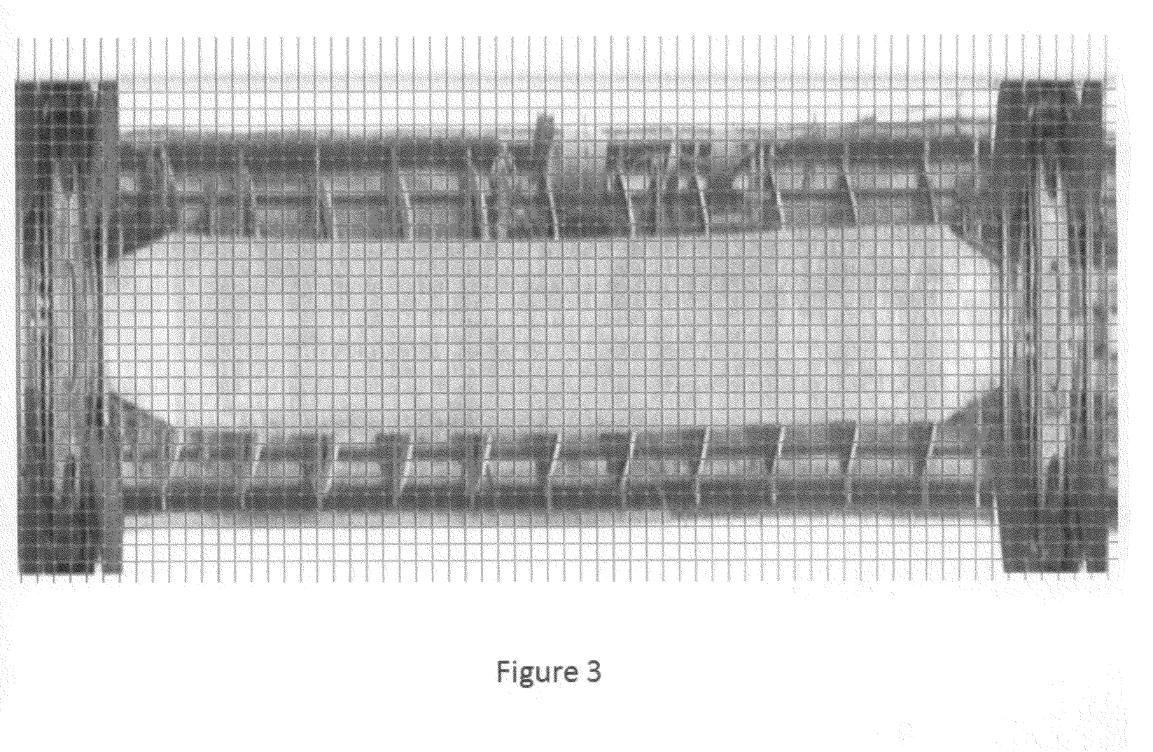

FIG. 1 is a block diagram of the dual mode undercarriage vehicle inspection system (003). The vehicle (002), such as a rail car, locomotive, passenger car or truck, is shown moving to the right in the figure on rails (008) or a road surface supported by wheels (006) and having an undercarriage (004). Recessed below the undercarriage are shown three map grid array sensors. Map grid array (016) is directed vertically, map grid array (012) is also vertical but tilted to the rear direction of the vehicle. Map grid array (019) is also vertical by tilted to the forward direction of the vehicle. The purpose of tilting the map grid arrays (012) and (019) is to detect areas of the undercarriage that may be hidden by a map grid array that is exactly vertical. Signatures are collected from all map grid array sensors and provided to the dual mode processor (030). The map grid arrays include radar sensors with outputs directed to the radar map processor section (032) of the dual mode processor (030). The map grid arrays also include electro-optical sensors with signature outputs directed to the electro-optical sensor section of the dual mode processor (030). Processor output is directed via network connection (050) to operator work station (040) containing work station computer (042) having archive memory capacity to record all system data for subsequent use. Also in the operator work station (050) is an alert device for the operator so that the dual mode processor (030) and provide an alert to the operator when an anomalous detection is made. Also indicated in FIG. 1 are indicated a camera (052) for vehicle tracking and control, a signal light (056) for controlling movement of the vehicle by its driver, and control gate (054) for controlling access to the undercarriage vehicle inspections system (003). Expanded detail of the dual mode undercarriage vehicle inspection system (003) is shown in FIG. 2. Typical individual radar sensors are shown (020) and are positioned in an array configuration (014). Typical individual electro-optical sensors are shown (010) and positioned in an array configuration (012). Radar sensor outputs connect to individual input ports on radar map processor section (032) within the dual mode processor (030). Electro-optical outputs connect to individual input ports on electro-optical map processor section (034) within the dual mode processor (030). Output of the dual mode processor (050) connects via network to the other components of the dual mode undercarriage vehicle inspection system (oo3). Other components include operator work station (040), camera for vehicle tracking and control (052), control gate for movement of vehicle (054) and signal light for movement of vehicle (056). Resolution of the dual mode undercarriage vehicle inspection system [DMUVIS] (003) is specified by the smallest anomalous object present that it can detect or by the smallest vacancy or displacement associated with a missing or damage part of the underside. Given a resolution specification size of length (l), width (w) and depth (d), it is clearly required to characterize the object resolution in three dimensions (l×w×d), not just two (l×w). Competitive UVIS products employ an image of the undercarriage and attempt to characterize an anomaly (threat object present or missing/damaged part) from a two dimensional image (l×w) using computer vision processing. That inadequacy is overcome by the DMUVIS sensors and processor, which produces three dimensional cell metrics for each two dimensional sector of the undercarriage. FIG. 3 shows a typical undercarriage for a rail vehicle with line markings to divide the undercarriage into horizontal grid sectors (l×w) but having three dimensional cell metrics (l×w×d). The entire array of three dimensional cells covering the undercarriage is designated as a map grid array and the metric record of cell dimensions is designated as a map grid array record which will have reference to a particular vehicle identity. Previous undercarriage inspection records are stored in the memory of the work station computer (042) and withdrawn for comparison with new vehicle map grid array record made by the dual mode processor (030) at the time of passage of the vehicle over the DMUVIS (003).

The radar sensors (014) measure range from the radar to each scattering sector of the undercarriage. Characterization of the depth (d) of each cell sector (l×w) is made by comparison of that measured depth with previous measurement for the same cell sector for the same vehicle undercarriage. Range is measured to the reference surface as the vehicle passes enabling that distance to be used for depth comparison for each sector cell (comparison to locate an anomaly by change of the range measurement d). The radar has a range resolution specification (Δr) determined by the radar design but is the smallest anomalous change in the range measurement detectable by the DMUVIS system. The depth (d) measured from the radar to each cell sector must agree with previous recorded (d) for that cell sector within the range (+/−Δd) to be recognized as a normal cell for that undercarriage and for that vehicle and not be designated as an anomalous cell. For normal operation the radar range resolution (Δr) should be less than the anomalous change specification Δd by a factor of three. That is Δd>3Δr to limit false anomaly detections caused by measurement error.

What I claim is:

1. Dual mode sensor apparatus and method, disposed below a rail bed or below a roadway, for inspecting a passing vehicle undercarriage configuration; the apparatus comprising: a map grid array of radar sensors aligned and bore sighted with a map grid array of electro-optical sensors across the lateral direction of the vehicle; processor; memory; map grid array record; automated operator workstation; method comprising detection and retention of a three dimensional map grid record of said vehicle's undercarriage, said three dimensional map grid record obtained by said processor fusing data output of said radar sensors with data output of said electro-optical sensors, comparing said three dimensional map grid array record of said vehicle undercarriage with a stored three dimensional map grid array record of said vehicle undercarriage for purpose of detection of one or more anomalous security threat objects and/or detection of equipment requiring maintenance.

2. The dual mode sensor method of claim 1 further characterized wherein each said radar sensor in said map grid array of radar sensors radiates, and collects, backscatter electromagnetic energy from a map grid sector of said vehicle underside (radar field-of-view) enabling determination of three dimensional cell metrics of said map grid array sector of said undercarriage defined by length L in the direction of vehicle motion, width W transverse to the direction of vehicle motion and depth D (vertical dimension) height of the said vehicle undercarriage.

3. The dual mode sensor apparatus of claim 1 further characterized wherein a multiplicity of said radar sensors is disposed in a map grid array such that a crosswise strip of said vehicle undercarriage is illuminated by electromagnetic energy from said map grid array of said radar sensors.

4. The dual mode sensor apparatus of claim 1 further characterized wherein a multiplicity of said electro-optical sensors is disposed in a map grid array such that each electro-optical sensor is aligned and bore-sighted with corresponding said radar sensor such that said individual electro-optical sensors encompass the same field-of-view as said individual radar sensors and whereas said map grid array of electro-optical sensors covers the same crosswise strip of said vehicle underside as said map grid array of radar sensors.

5. The dual mode sensor method of claim 1 further characterized wherein the respective output signatures of said map grid array of radar sensors and said linear array of electro-optical sensors are electronically fused to create a high resolution three dimensional map grid array record of said vehicle undercarriage.

6. The dual mode sensor method of claim 5 further characterized wherein said radar sensor signature and said electro-optical signature are fused directly to create a three dimensional map of said vehicle undercarriage composed of strips having width L transverse to the direction of motion of the vehicle and extending the entire width (W) of the vehicle. Said three dimensional undercarriage map grid array record to be composed of said strips, each said strip array collected sequentially as said vehicle moves over the sensors, and extending the length of said vehicle.

7. The dual mode sensor method of claim 5 further characterized, alternatively, wherein said radar sensor map grid array signatures are used to create a digital range map record over said undercarriage of said vehicle and said electro-optical sensor signatures are used to create a cross-range map record over said undercarriage of said vehicle and wherein said digital range map record and said digital cross-range map record are subsequently fused to create a digital three dimensional map record of said vehicle undercarriage. Said three dimensional map array record to be composed of said array strips and extending the length of said vehicle undercarriage.

8. The dual mode sensor apparatus and method of claim 1 further characterized by a processor, processor algorithms, operator alert device and operator work station. Said operator work station to enable a human operator to initiate corrective action in response to automated anomaly alert initiated by said processor algorithms and presented on said alert device if said vehicle inspection result identifies condition of anomalous object presence or anomalous condition of equipment. Said processor algorithms designed to compare said undercarriage three dimensional map grid record to an archival three dimensional map grid map for the same vehicle and to recognize changes as basis for presentation of said alert to said operator on said alert device if anomalous conditions are detected. Anomalous conditions may include (1) an explosive device attached to the undercarriage (2) a missing or changed component of the undercarriage equipment that justifies maintenance alert by said processor to said human operator using said alert device.

9. The dual mode sensor apparatus and method of claim 1 further characterized by short range radar sensors operating at millimeter wavelengths, capable of high resolution ranging by transmitter frequency modulation having frequency modulated continuous wave (FM-CW) and featuring antennas having high gain, low side-lobes and narrow beam angle to illuminate said map grid array sector (L×W) field-of-view to facilitate clutter-free backscatter signatures from said undercarriage for input to data processor.

10. The dual mode sensor apparatus and method of claim 1 further characterized by high cross-range resolution electro-optical sensors of wavelength suitable for operation day and night in the cluttered environment below the vehicle in the presence of dust, dirt, snow, ice and providing signatures for input to the data processor for fusion with said radar signatures.
